(19) United States
(12) Patent Application Publication
(10) Pub. No.: US 2026/0016623 A1
(43) Pub. Date: Jan. 15, 2026

(54) LAMINATE AND VIRTUAL REALITY DISPLAY DEVICE

(71) Applicant: FUJIFILM Corporation, Tokyo (JP)

(72) Inventor: Yoshinori MAEDA, Kanagawa (JP)

(73) Assignee: FUJIFILM Corporation, Tokyo (JP)

(21) Appl. No.: 19/338,620

(22) Filed: Sep. 24, 2025

Related U.S. Application Data
(63) Continuation of application No. PCT/JP2024/008509, filed on Mar. 6, 2024.

(30) Foreign Application Priority Data
Mar. 29, 2023 (JP) 2023-053217

(51) Int. Cl. G02B 5/30; G02B 1/08

(52) U.S. Cl. CPC G02B 5/305; G02B 1/08

(57) ABSTRACT

A laminate having excellent heat resistance and excellent image sharpness when applied to a pancake lens type virtual reality display device, and a virtual reality display device. The laminate includes an absorption type polarizer that is a stretched resin film, a first protective layer disposed on one surface side of the absorption type polarizer, and a second protective layer disposed on the other surface side of the absorption type polarizer, in which the laminate has a curved surface portion, the absorption type polarizer contains a resin having a crosslinked portion, an amount of a crosslinking agent derived from the crosslinked portion is 0.050×10⁻⁶ g/m³ or less, thicknesses of both the first protective layer and the second protective layer are 0.10 to 10 μm, and both the first and the second protective layer contain a resin selected from the group consisting of an acrylic resin and a methacrylic resin.

### CROSS-REFERENCE TO RELATED APPLICATIONS

This application is a Continuation of PCT International Application No. PCT/JP2024/008509 filed on Mar. 6, 2024, which was published under PCT Article 21(2) in Japanese, and which claims priority under 35 U.S.C. § 119(a) to Japanese Patent Application No. 2023-053217 filed on Mar. 29, 2023. The above applications are hereby expressly incorporated by reference, in their entirety, into the present application.

### BACKGROUND OF THE INVENTION

### 1. Field of the Invention

The present invention relates to a laminate and a virtual reality display device.

### 2. Description of the Related Art

A virtual reality display device is a display device which can obtain a realistic effect as if entering a virtual world by wearing a dedicated headset on a head and visually recognizing a video displayed through a lens.

The virtual reality display device generally includes an image display panel and a Fresnel lens, but a distance from the image display panel to the Fresnel lens is large, and thus a headset is thick and has poor wearability, which are problems.

Accordingly, JP2020-519964A discloses a lens configuration called a pancake lens including an image display panel, a reflective polarizer, and a half mirror, in which the total thickness of the headset decreases by causing a beam emitted from the image display panel to reciprocate between the reflective polarizer and the half mirror.

### SUMMARY OF THE INVENTION

In the pancake lens type virtual reality display device, further improvement in image sharpness is required.

In the virtual reality display device described in JP2020-519964A, an absorption type polarizer is used. The absorption type polarizer needs to have a curved surface shape according to the shape of a lens or the like. The present inventors have applied a conventional absorption type polarizer to a virtual reality display device and evaluated the characteristics thereof, and have found that the image sharpness does not satisfy a higher level of requirements in recent years and further improvement is required.

In addition, the absorption type polarizer to be used is required to have high heat resistance. The heat resistance means that a change in transmittance, which is an optical characteristic, is suppressed even after the absorption type polarizer is allowed to stand in a high-temperature and high-humidity environment.

In view of the above circumstances, an object of the present invention is to provide a laminate having excellent heat resistance and excellent image sharpness in a case of being applied to a pancake lens type virtual reality display device.

Another object of the present invention is to provide a virtual reality display device.

The present inventors have conducted intensive studies on the above-described problems and have found that the above-described problems can be solved by the following configurations.

(1) A laminate including an absorption type polarizer that is a stretched resin film, a first protective layer disposed on one surface side of the absorption type polarizer, and a second protective layer disposed on the other surface side of the absorption type polarizer, in which the laminate has a curved surface portion, the absorption type polarizer contains a resin having a crosslinked portion, an amount of a crosslinking agent derived from the crosslinked portion is 0.050×10⁻⁶ g/m³ or less, thicknesses of both the first protective layer and the second protective layer are 0.10 to 10 μm, and both the first protective layer and the second protective layer contain a resin selected from the group consisting of an acrylic resin and a methacrylic resin.

(2) A laminate including an absorption type polarizer that is a stretched resin film, a first protective layer disposed on one surface side of the absorption type polarizer, and a second protective layer disposed on the other surface side of the absorption type polarizer, in which the laminate has a curved surface portion, the absorption type polarizer contains a resin having a boric acid crosslinked portion, an amount of a boric acid derived from the boric acid crosslinked portion is 0.050×10⁻⁶ g/m³ or less, thicknesses of both the first protective layer and the second protective layer are 0.10 to 10 μm, and both the first protective layer and the second protective layer contain a resin selected from the group consisting of an acrylic resin and a methacrylic resin.

(3) The laminate according to (1) or (2), in which the absorption type polarizer contains iodine and a polyvinyl alcohol-based resin.

(4) A virtual reality display device including in the following order, an image display panel, an absorption type polarizer, a first retardation layer, a half mirror, a second retardation layer, a reflective polarizer, and the laminate according to (1) to (3).

(5) A virtual reality display device including in the following order, an image display panel, an absorption type polarizer, a retardation layer, a half mirror, a reflective circular polarizer, and the laminate according to (1) to (3).

According to the present invention, it is possible to provide a laminate which has excellent heat resistance and excellent image sharpness in a case of being applied to a pancake lens type virtual reality display device.

According to the present invention, it is possible to provide a virtual reality display device.

### BRIEF DESCRIPTION OF THE DRAWINGS

FIG. 1 is a top view of an example of a laminate according to the embodiment of the present invention.

FIG. 2 is a cross-sectional view taken along line A-A in FIG. 1.

FIG. 3 is a diagram showing an example of a first embodiment of the virtual reality display device of the present invention.

FIG. 4 is a view showing an example of a second embodiment of the virtual reality display device of the present invention.

### DESCRIPTION OF THE PREFERRED EMBODIMENTS

Hereinafter, the present invention will be described in detail.

The description of the configuration requirements described below may be made based on representative embodiments and specific examples, but the present invention is not limited to such embodiments.

In the present specification, numerical ranges represented by “to” include numerical values before and after “to” as lower limit values and upper limit values.

In the present specification, a term “absorption axis” denotes a polarization direction in which absorbance is maximized in a plane in a case where linearly polarized light is incident. In addition, a term “reflection axis” denotes a polarization direction in which a reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which a refractive index is maximized in a plane.

In the present specification, Re(λ) and Rth(λ) represent an in-plane direction retardation and a thickness-direction retardation at a wavelength λ, respectively. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d) to AxoScan, the followings are calculated.
Slow Axis Direction) (°)

$$R e ( λ ) = R 0 ( λ )$$

$$Rth ( λ ) = ( ( n x + ny ) / 2 nz ) \times d$$

Although R0(λ) is described as a numerical value calculated by AxoScan, it means Re(λ).

In addition, in the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. Examples of values of the average refractive indices of main optical films are as follows: cellulose acylate (1.48), cycloolefin polymer (1.52), polycarbonate (1.59), polymethylmethacrylate (1.49), and polystyrene (1.59).

A feature point of the laminate according to the embodiment of the present invention is that the amount of the crosslinking agent derived from the crosslinked portion (preferably, the amount of the boric acid derived from the boric acid crosslinked portion, which will be described later) is equal to or smaller than a predetermined value, and a protective layer which includes a predetermined resin and has a thickness in a predetermined range is used.

The present inventors have conducted studies on the cause of the fact that a desired effect is not obtained in a case where an absorption type polarizer, which is a stretched resin film in the related art, is applied to a pancake lens type virtual reality display device, and have found that the image sharpness is deteriorated because the surface properties of the absorption type polarizer are deteriorated in a case where the absorption type polarizer is molded into a curved surface shape. Therefore, the present inventors have conducted intensive studies, and have found that the deterioration of the surface properties can be prevented by reducing the amount of the crosslinking agent derived from the crosslinked portion. The reduction in the amount of the crosslinking agent derived from the crosslinked portion means a decrease in the crosslinking density, and as a result, it is presumed that the absorption type polarizer is easily stretched in a case of being molded into a curved surface shape, distortion during stretching is suppressed, and deterioration in the surface properties is prevented.

In addition, in the laminate according to the embodiment of the present invention, by using a protective layer which contains a predetermined resin and has a thickness in a predetermined range, the heat resistance is improved. The present inventors have found that the transmittance of the absorption type polarizer changes due to the diffusion of the dichroic substance contained in the absorption type polarizer into the adjacent layer as a mechanism that deteriorates the heat resistance. Therefore, it is presumed that, by disposing a protective layer which contains a predetermined resin as a layer adjacent to the absorption type polarizer and has a predetermined thickness, although the dichroic substance diffuses into the protective layer, the thickness of the protective layer is small, and thus the concentration of the dichroic substance tends to be high, and as a result, the concentration gradient between the absorption type polarizer and the protective layer is small, the diffusion of the dichroic substance is suppressed, and the change in transmittance is suppressed.

### <Laminate>

The laminate according to the embodiment of the present invention includes an absorption type polarizer which is a stretched resin film, a first protective layer disposed on one surface side of the absorption type polarizer, and a second protective layer disposed on the other surface side of the absorption type polarizer.

The laminate according to the embodiment of the present invention has a curved surface portion.

The entire laminate may be a curved surface portion, or a part of the laminate may be a curved surface portion. In a case where a part of the laminate is a curved surface portion, the other part may be a flat surface portion.

The curved surface portion means a portion having a curved surface shape.

The above-described curved surface shape means a shape having a curvature of more than 0, and includes a curved surface shape which is a developable surface and a three-dimensional curved surface shape. The developable surface is a surface which is developable onto a plane without stretching or contracting any part of the surface.

Examples of the curved surface shape which is a developable surface include surfaces corresponding to a cylindrical peripheral surface, an elliptical cylindrical peripheral surface, a conical peripheral surface, an elliptical conical peripheral surface, and the like; and the curved surface shape may be a convex curved surface or a concave curved surface. The three-dimensional curved surface is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational parabolic surface). The three-dimensional curved shape may be a convex curved surface or a concave curved surface.

The curved surface shape is preferably lens-like. Examples of the lens-like curved surface shape include a rotating body shape such as spherical surface shape and a rotating elliptical surface shape, and the lens-like curved surface shape may be a convex lens-like shape or a concave lens-like shape.

The shape of the curved surface portion of the laminate is preferably a spherical surface shape, a rotational ellipsoid shape, or a rotational parabolic surface shape. That is, it is preferable that the curved surface portion is a spherical surface shape portion, a rotational ellipsoid shape portion, or a rotational parabolic surface shape portion.

As described above, the shape of the curved surface portion of the laminate is preferably a rotating body shape.

The curvature radius of the curved surface portion of the laminate is not particularly limited, but is preferably 20 to 80 mm and more preferably 30 to 80 mm.

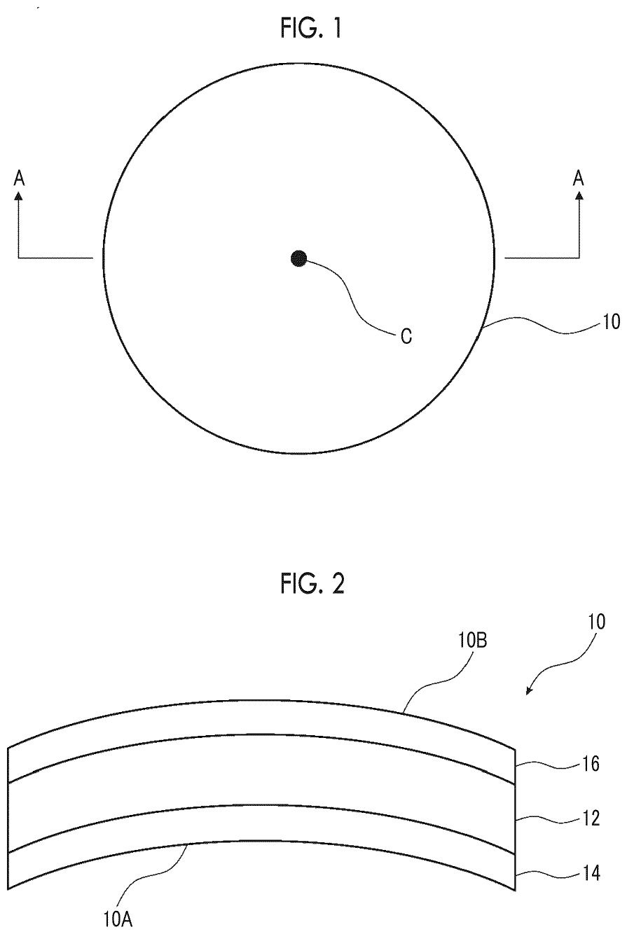

FIG. 1 shows an example of a laminate according to the embodiment of the present invention.

FIG. 1 is a top view of a laminate, and FIG. 2 is a cross-sectional view taken along line A-A of FIG. 1. The line A-A is a line passing through the center C of the laminate 10 which is circular in a plan view.

As shown in FIGS. 1 and 2, the laminate 10 includes an absorption type polarizer 12, a first protective layer 14 disposed on one surface of the absorption type polarizer 12, and a second protective layer 16 disposed on the other surface of the absorption type polarizer 12.

In addition, as shown in FIGS. 1 and 2, the laminate 10 has a curved surface shape. More specifically, as shown in FIG. 2, the laminate 10 has a shape that is curved in a convex shape toward the upper side of the paper surface. That is, the laminate 10 has a convex shape protruding to one surface side. It is noted that the laminate 10 can also be said to have a recessed shape in which the other surface side is recessed.

In the laminate 10, the entire laminate 10 corresponds to the curved surface portion.

As shown in FIG. 2, the laminate 10 has two first surface 10A and second surface 10B facing each other, the first surface 10A is a curved surface convex toward the upper side of the paper surface, and the second surface 10B is a curved surface convex toward the upper side of the paper surface.

The curved surface shape of the laminate 10 shown in FIGS. 1 and 2 is a rotational parabolic surface shape, but may be a spherical surface shape or a rotational ellipsoid shape.

As shown in FIG. 1, in a case where the laminate 10 is observed from a normal direction of a tangent plane of the center C (corresponding to the apex of the protrusion) of the laminate 10 (in a case where the laminate 10 is viewed in a plan view), the shape of the laminate 10 is circular.

The center C of the laminate 10 is an intersection between an axis of the rotational ellipsoid shape and the laminate 10, and corresponds to a position where the center of the emission surface of the image display device intersects with the normal line in a case where the laminate 10 is incorporated into a virtual reality display device described later.

In a case where the laminate 10 is incorporated into a virtual reality display device described below, the laminate 10 is disposed to be convex toward the image display panel side.

In FIG. 1, an aspect in which the shape of the curved surface portion of the laminate is circular in a case of being viewed in a plan view (in a case of being observed from the rotation axis direction of the laminate) has been described, but the present invention is not limited to this aspect, and the shape of the curved surface portion of the laminate in a case of being viewed in a plan view may be elliptical or may be another shape.

Hereinafter, each member included in the laminate will be described in detail.

### <Absorption Type Polarizer>

The laminate according to the embodiment of the present invention includes an absorption type polarizer (absorptive linear polarizer) which is a stretched resin film.

The stretched resin film is a film obtained by stretching a resin film.

The polarization degree of the absorption type polarizer is not particularly limited, but from the viewpoint that the performance of the virtual reality display device to which the laminate is applied is more excellent, the polarization degree is preferably 99.0% or more, more preferably 99.5% or more, and still more preferably 99.9% or more. The upper limit thereof is not particularly limited, and examples thereof include 100%.

A method of measuring the polarization degree of the absorption type polarizer is as follows.

First, a part (particularly, a central portion) of the absorption type polarizer is cut out in a size of 2 cm square and bonded to FUJITAC TD80UL (manufactured by Fujifilm Corporation) with a pressure-sensitive adhesive sheet “NCF-D692 (5)” manufactured by LINTEC Corporation, and then the visibility-corrected polarization degree is calculated using an automatic polarizing film measuring device VAP-7070 (manufactured by JASCO Corporation).

Here, the “visibility-corrected polarization degree” refers to an average value of values obtained by measuring transmittance in a wavelength range of 380 to 780 nm incident from the FUJITAC TD80UL side by installing a light source, a linear polarizer, and an absorption type polarizer in this order, calculating the polarization degree at each wavelength by the following expression, and multiplying the calculated value by a visibility correction coefficient.

$$Polarization degree P ( \% ) = {\{ ( Ty - Tx ) / ( Ty + T x ) \}}^{1 / 2} \times 100$$

Tx: transmittance in a case where the incidence polarized light emitted through the linear polarizer and the transmission axis of the absorption type polarizer 1 are arranged to be crossed nicols (incident light is 100%)
Ty: transmittance in a case where the incidence polarized light emitted through the linear polarizer and the transmission axis of the absorption type polarizer 1 are arranged to be parallel-nicols (incident polarized light is 100%)

The absorption type polarizer contains a resin. The type of the resin is not particularly limited, and examples thereof include known resins. Examples of the resin include a polyvinyl alcohol-based resin, a (meth)acrylic resin, a styrene-based resin, and a cellulose-based resin.

Among these, a polyvinyl alcohol-based resin is preferable, and examples thereof include polyvinyl alcohol and derivatives thereof. Examples of the derivative of polyvinyl alcohol include polyvinyl formal; polyvinyl acetal; and a product obtained by modifying polyvinyl alcohol, polyvinyl formal, polyvinyl acetal, or the like with an olefin such as ethylene or propylene, or an unsaturated carboxylic acid such as acrylic acid, methacrylic acid, or crotonic acid.

The average degree of polymerization of the polyvinyl alcohol-based resin is preferably 100 to 10,000 and more preferably 1,000 to 10,000.

In addition, the saponification degree of the polyvinyl alcohol-based resin is preferably 80% to 100% by mole and more preferably 95% to 99.95% by mole.

The average degree of polymerization and the saponification degree can be determined in accordance with JIS K 6726.

The resin in the absorption type polarizer has a crosslinked portion. The crosslinked portion is a linking portion formed using a known crosslinking agent.

The type of the crosslinking agent is not particularly limited, but in a case where the polyvinyl alcohol-based resin described above is used as the resin, the crosslinking agent is preferably boric acid. That is, the absorption type polarizer may contain a resin having a boric acid crosslinked portion. The boric acid crosslinked portion is a crosslinked portion generated in a case where boric acid is used as a crosslinking agent, and is formed by boric acid and a hydroxyl group contained in the resin.

The amount of the crosslinking agent derived from the crosslinked portion is 0.050×10⁻⁶ g/m³ or less, and is preferably 0.045×10⁻⁶ g/m³ or less from the viewpoint that the image sharpness is more excellent in a case where the laminate according to the embodiment of the present invention is applied to a pancake lens type virtual reality display device. In addition, from the viewpoint that the heat resistance of the laminate is more excellent, the content of the metal element is preferably 0.010×10⁻⁶ g/m³ or more, more preferably 0.020×10⁻⁶ g/m³ or more, and still more preferably 0.030×10⁻⁶ g/m³ or more.

In a case where the crosslinked portion is a boric acid crosslinked portion, the amount of the crosslinking agent corresponds to the amount of boric acid.

The method of calculating the amount of the crosslinking agent derived from the crosslinked portion is not particularly limited, and examples thereof include known methods. Examples thereof include a method of cleaving the bond in the crosslinked portion to extract the crosslinking agent constituting the crosslinked portion and measuring the content thereof.

More specifically, in a case where the crosslinked portion is a boric acid crosslinked portion, the amount of boric acid can be calculated by the following procedure. First, the absorption type polarizer is cut into 1 cm×1 cm, 3 cc of nitric acid is added thereto, and then ashing treatment is performed at a maximum temperature of 230° C. by microwave. Water is added to the obtained product to make the total amount 50 g, and then the luminescence intensity of boron is measured using ICP-OES (Optima 7300DV) manufactured by PerkinElmer Inc.

Next, a plurality of aqueous solutions having known boric acid concentrations are prepared, and a calibration curve showing a relationship between a boric acid amount and a luminescence intensity is prepared from the ICP luminescence intensity data of boron measured using each aqueous solution. Using this calibration curve, the amount (g) of boric acid is calculated from the luminescence intensity data of boron measured using the sample of the absorption type polarizer. Next, the calculated amount of boric acid (g) is divided by the volume (1 cm×1 cm× thickness) of the sample to calculate the amount of boric acid (g/m³).

The content of the resin in the absorption type polarizer is not particularly limited, but is preferably 50% to 99% by mass and more preferably 75% to 99% by mass with respect to the total mass of the absorption type polarizer.

The absorption type polarizer preferably includes a dichroic substance.

The dichroic substance means a substance having different absorbances depending on directions.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (preferably, dichroic coloring agents) of the related art can be used.

Among these, iodine is preferable as the dichroic substance. The iodine may be present in an ionic state.

In a case where the absorption type polarizer contains iodine and a polyvinyl alcohol-based resin (PVA), the iodine may be present in the absorption type polarizer in the form of I⁻, I₂, I₃⁻, I₃⁻-PVA complex, I₅³¹-PVA complex, or the like.

The content of the dichroic substance in the absorption type polarizer is not particularly limited, but is preferably 0.1 to 1.5 g/m² and more preferably 0.1 to 1.0 g/m².

The g/m² represents the content (g) of the dichroic substance per unit area (m²) of the absorption type polarizer.

The absorption type polarizer may include components other than the above-described resin and dichroic substance. Examples of the other components include a plasticizer.

### <First Protective Layer and Second Protective Layer>

The laminate according to the embodiment of the present invention includes a first protective layer and a second protective layer. The first protective layer and the second protective layer are disposed on both sides of the absorption type polarizer to prevent the dichroic substance from diffusing. Both the first protective layer and the second protective layer may function as a pressure sensitive adhesive layer.

Both the first protective layer and the second protective layer are in contact with the absorption type polarizer.

The thicknesses of the first protective layer and the second protective layer are both 0.10 to 10 μm. Among these, from the viewpoint that the heat resistance of the laminate is more excellent, the thickness of the metal layer is preferably 0.10 to 8.0 μm and more preferably 0.10 to 6.0 μm. In a case where the thickness is 0.1 μm or more, the protective properties of the absorption type polarizer are improved, and the adhesiveness is excellent in a case where the first protective layer or the second protective layer functions as the pressure sensitive adhesive layer. In addition, in a case where the thickness is 10 μm or less, the heat resistance of the laminate is excellent.

The above-described thickness is an average thickness, and a method of obtaining the average thickness is as follows.

First, the cross section of the laminate is exposed, the thickness of the first protective layer (or the second protective layer) is measured at 20 or more points, the values are arithmetically averaged to obtain an average thickness, and this value is taken as the thickness of the first protective layer (or the second protective layer).

Both the first protective layer and the second protective layer contain a resin selected from the group consisting of an acrylic resin and a methacrylic resin (hereinafter, also simply referred to as a “(meth)acrylic resin”).

The (meth)acrylic resin is a polymer in which a monomer having a (meth)acryloyl group is a main component among monomers constituting the (meth)acrylic resin. Here, the main component refers to a monomer having the highest content (% by mass) among monomer components constituting the (meth)acrylic resin.

The (meth)acryloyl group means a group selected from the group consisting of an acryloyl group and a methacryloyl group.

The number of (meth)acryloyl groups contained in the monomer having a (meth)acryloyl group is not particularly limited, but is preferably 1 to 3.

Examples of the monomer having a (meth)acryloyl group include alkyl (meth)acrylate. Examples of the alkyl (meth)acrylate include an alkyl group having 1 to 20 carbon atoms, and the alkyl group may be linear or branched. Examples of the alkyl (meth)acrylate include methyl (meth)acrylate, ethyl (meth)acrylate, isopropyl (meth)acrylate, n-propyl (meth)acrylate, n-butyl (meth)acrylate, 2-ethylhexyl (meth)acrylate, n-octyl (meth)acrylate, isooctyl (meth)acrylate, nonyl (meth)acrylate, decyl (meth)acrylate, undecyl (meth)acrylate, and dodecyl (meth)acrylate.

The alkyl (meth)acrylate may be used alone or in combination of two or more kinds thereof.

The content of the repeating unit derived from the alkyl (meth)acrylate in the (meth)acrylic resin is not particularly limited, but from the viewpoint that the heat resistance of the laminate is more excellent, it is preferably 70% to 100% by mass and more preferably 80% to 100% by mass.

Examples of other monomers other than the alkyl (meth)acrylate include monomers having a reactive group (for example, a hydroxyl group, a carboxyl group, an amino group, an epoxy group, and the like) and monomers having an aromatic ring.

The other monomer is preferably a monomer having a (meth)acryloyl group.

The content of the (meth)acrylic resin in the first protective layer is not particularly limited, but is preferably 50% to 100% by mass, and more preferably 75% to 99% by mass with respect to the total mass of the first protective layer.

The content of the (meth)acrylic resin in the second protective layer is not particularly limited, but is preferably 50% to 100% by mass, and more preferably 75% to 99% by mass with respect to the total mass of the second protective layer.

### <Production Method of Laminate>

A method for producing the laminate is not particularly limited, and a known method is adopted.

For example, a method of obtaining an absorption type polarizer which is a stretched resin film, forming a first protective layer and a second protective layer on both surfaces of the obtained absorption type polarizer, and then forming a curved surface portion is preferable.

Hereinafter, the procedure of the above-described method will be described in detail.

A method of obtaining the absorption type polarizer is not particularly limited, and examples thereof include known methods.

In a case where the absorption type polarizer contains iodine and a polyvinyl alcohol-based resin, and the crosslinked portion is a boric acid crosslinked portion, it is preferable to perform the following steps 1 to 6. As will be described later, boric acid is used in the step 3 and the step 5, and boric acid is also used in the step 6 as necessary. By adjusting the amount of boric acid used in these steps, the amount of boric acid derived from the boric acid crosslinked portion described above can be adjusted.
Step 1: A step of applying a composition including a polyvinyl alcohol-based resin onto a base material to form a resin layer on the base material, thereby obtaining a pre-stretch film
Step 2: A step of stretching the pre-stretch film obtained in the step 1 (air-assisted stretching treatment step)
Step 3: A step of bringing the stretched film into contact with boric acid (insolubilization treatment step)
Step 4: A step of dyeing the film obtained in the step 3 with iodine (dyeing treatment step)
Step 5: A step of bringing the film obtained in the step 4 into contact with boric acid (crosslinking treatment step)
Step 6: A step of stretching the film obtained in the step 5 in an aqueous solution (in-water stretching treatment step)

Hereinafter, the procedure of each step will be described in detail.

The step 1 is a step of applying a composition containing a polyvinyl alcohol-based resin onto a base material to form a resin layer on the base material, thereby obtaining a pre-stretch film.

The polyvinyl alcohol-based resin contained in the composition containing a polyvinyl alcohol-based resin is as described above.

The composition may contain a solvent. Examples of the solvent include water and an organic solvent.

The composition may contain a halide from the viewpoint of improving the alignment of the polyvinyl alcohol molecules due to stretching. Examples of the halide include iodide and sodium chloride. Examples of the iodide include potassium iodide, sodium iodide, and lithium iodide.

The base material used in the step 1 is not particularly limited, and a thermoplastic resin base material is preferable.

Examples of the constituent material of the thermoplastic resin base material include an ester-based resin such as a polyethylene terephthalate-based resin, a cycloolefin-based resin such as a norbornene-based resin, an olefin-based resin such as polypropylene, a polyamide-based resin, a polycarbonate-based resin, and a copolymer resin thereof.

Examples of the method of applying the composition include a roll coating method, a spin coating method, a wire bar coating method, a dip coating method, a die coating method, a curtain coating method, a spray coating method, and a knife coating method (comma coating method and the like).

The step 2 is a step of stretching the pre-stretch film obtained in the step 1.

Examples of the method of the stretching treatment in this step include fixed-end stretching (for example, a method of stretching using a tenter stretching machine) and free-end stretching (for example, a method of uniaxially stretching the film by passing the film between rolls having different circumferential speeds).

The stretching ratio is preferably 2.0 to 3.5 times.

The stretching may be performed in one stage or in multiple stages.

The stretching temperature is, for example, preferably equal to or higher than the glass transition temperature (Tg) of the thermoplastic resin base material, and more preferably equal to or higher than the glass transition temperature (Tg)+10° C.

The step 3 is a step of bringing the stretched film into contact with boric acid.

The procedure of this step is not particularly limited, and examples thereof include a method of immersing the film in an aqueous boric acid solution.

The content of the boric acid in the boric acid aqueous solution is preferably 1 to 10 parts by mass with respect to 100 parts by mass of water.

The liquid temperature of the boric acid aqueous solution is preferably 20° C. to 50° C.

The step 4 is a step of staining the film obtained in the step 3 with iodine.

The procedure of this step is not particularly limited, and examples thereof include a method of immersing the film in a dyeing liquid containing iodine, a method of coating the film with the dyeing liquid, and a method of spraying the film with the dyeing liquid.

The content of iodine in the dyeing liquid is preferably 0.05 to 0.5 parts by mass with respect to 100 parts by mass of water.

In order to increase the solubility of iodine in water, the dyeing liquid preferably contains an iodide. The content of the iodide in the dyeing liquid is preferably 0.1 to 10 parts by mass, and more preferably 0.3 to 5 parts by mass with respect to 100 parts by mass of water.

The liquid temperature of the dyeing liquid is preferably 20° C. to 50° C.

The contact time between the film and the iodine is preferably 5 seconds to 5 minutes and more preferably 30 to 90 seconds.

The ratio (iodine/iodide) of the content of iodine and the content of the iodide in the dyeing liquid is preferably ⅕ to 1/20, and more preferably ⅕ to 1/10.

The step 5 is a step of bringing the film obtained in the step 4 into contact with boric acid.

The procedure of this step is not particularly limited, and examples thereof include a method of immersing the film in an aqueous boric acid solution.

The content of the boric acid in the boric acid aqueous solution is preferably 1 to 10 parts by mass with respect to 100 parts by mass of water.

The liquid temperature of the boric acid aqueous solution is preferably 20° C. to 50° C.

The step 6 is a step of stretching the film obtained in the step 5 in an aqueous solution.

As the aqueous solution used in the present step, a boric acid aqueous solution is preferable.

The content of the boric acid in the boric acid aqueous solution is preferably 1 to 10 parts by mass and more preferably 2.5 to 6 parts by mass with respect to 100 parts by mass of water.

In addition, the boric acid aqueous solution may contain iodide.

The liquid temperature of the aqueous solution is preferably 40° C. to 85° C. and more preferably 60° C. to 75° C.

The immersion time of the film in the aqueous solution is preferably 15 seconds to 5 minutes.

Examples of the method of the stretching treatment in this step include fixed-end stretching (for example, a method of stretching using a tenter stretching machine) and free-end stretching (for example, a method of uniaxially stretching through rolls having different circumferential speeds).

The stretching ratio is preferably 1.5 times or more and more preferably 3 times or more.

The film obtained in the step 6 may be further subjected to a washing treatment and a drying treatment.

A method of forming the first protective layer and the second protective layer on both surfaces of the obtained absorption type polarizer is not particularly limited, and examples thereof include a method of forming the first protective layer (or the second protective layer) by applying a composition containing a (meth)acrylic resin onto a surface of the absorption type polarizer.

The (meth)acrylic resin contained in the composition is as described above.

The composition may contain a solvent. Examples of the solvent include water and an organic solvent.

Examples of the method of applying the composition include a roll coating method, a spin coating method, a wire bar coating method, a dip coating method, a die coating method, a curtain coating method, a spray coating method, and a knife coating method (comma coating method and the like).

In addition, examples of another method include a method of separately applying the composition onto a temporary support to form the first protective layer (or the second protective layer) and transferring the first protective layer (or the second protective layer) to the absorption type polarizer.

A method of forming the curved surface portion is not particularly limited, and a known method can be used. For example, a method of forming a laminate including the first protective layer, the absorption type polarizer, and the second protective layer using a molding die having a concave surface shape or a convex surface shape is exemplified.

### <Virtual Reality Display Device>

Examples of the first embodiment of the virtual reality display device according to the embodiment of the present invention include a virtual reality display device including an image display panel, an absorption type polarizer, a first retardation layer, a half mirror, a second retardation layer, a reflective polarizer, and the laminate in this order.

In addition, examples of the second embodiment of the virtual reality display device according to the embodiment of the present invention include a virtual reality display device including an image display panel, an absorption type polarizer, a retardation layer, a half mirror, a reflective circular polarizer, and the laminate in this order.

Hereinafter, each embodiment will be described with reference to the drawings.

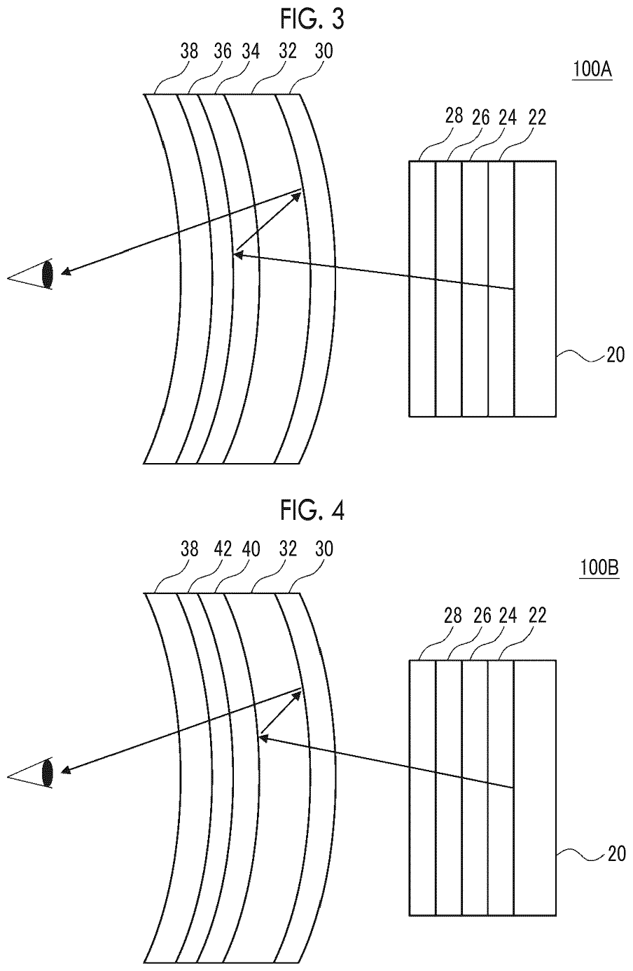

A virtual reality display device 100A shown in FIG. 3 includes an image display panel 20, a λ/4 retardation layer 22, an absorption type polarizer 24, a λ/4 retardation layer 26, an antireflection layer 28, a half mirror 30, a lens base material 32, a λ/4 retardation layer 34, a reflective polarizer 36, and a laminate 38 in this order.

The laminate 38 includes the above-described first protective layer, an absorption type polarizer, and a second protective layer.

In the example shown in FIG. 3, the λ/4 retardation layer 22, the absorption type polarizer 24, the λ/4 retardation layer 26, and the antireflection layer 28 are laminated in this order on the display surface side of the image display panel 20.

The lens base material 32 is disposed at a predetermined distance from the image display panel 20 (antireflection layer 28) and spaced apart from the image display panel 20, and has a surface on the image display panel 20 side, which is a convex surface, and a surface on the opposite side, which is a concave surface.

The half mirror 30 is laminated on the convex surface side of the lens base material 32 and is curved along a curved surface shape of the convex surface of the lens base material 32.

On the concave surface side of the lens base material 32, the λ/4 retardation layer 34, the reflective polarizer 36, and the laminate 38 are laminated in this order, and are each curved along the curved surface shape of the concave surface of the lens base material 32.

In such a virtual reality display device 100A, in a case where light (video light) of unpolarized light is emitted from the image display panel 20, the light passes through the λ/4 retardation layer 22 as the unpolarized light, is converted into linearly polarized light by the absorption type polarizer 24, and is converted into circularly polarized light by the λ/4 retardation layer 26. That is, the transmission axis of the absorption type polarizer 24 and the slow axis of the λ/4 retardation layer 26 are disposed to be at an angle of 45°.

As an example, in a case where the levorotatory circularly polarized light is converted by the λ/4 retardation layer 26, the levorotatory circularly polarized light is incident on the half mirror 30.

About half of the left circularly polarized light incident into the half mirror 30 transmits through the half mirror 30, transmits through the lens base material 32, is incident into the λ/4 retardation layer 34 to be converted into linearly polarized light, and the linearly polarized light is incident into the reflective polarizer 36. The reflective polarizer 36 is disposed to reflect the incident linearly polarized light. Therefore, the linearly polarized light reflected by the reflective polarizer 36 is reflected toward the half mirror 30 side. The linearly polarized light reflected from the reflective polarizer 36 is converted into left circularly polarized light by the λ/4 retardation layer 34. About half of the left circularly polarized light incident into the half mirror 30 is reflected by the half mirror 30. In this case, the levorotatory circularly polarized light is converted into dextrorotatory circularly polarized light.

The right circularly polarized light reflected from the half mirror 30 transmits through the lens base material 32, is incident into the λ/4 retardation layer 34 to be converted into linearly polarized light, and the linearly polarized light is incident into the reflective polarizer 36. Since the reflective polarizer 36 is disposed to allow transmission of the incident linearly polarized light, the incident linearly polarized light transmits through the reflective polarizer 36 and is incident into the laminate 38. The absorption type polarizer included in the laminate 38 is disposed to allow transmission of the linearly polarized light, and thus the linearly polarized light also transmits through the laminate 38 and is emitted toward the user U. Here, in a case of being viewed from the user U side, since the half mirror 30 is formed into a concave shape, light is emitted to the viewing side in a state in which the light is converged more than immediately after being emitted from the image display panel 20 by the action of the concave mirror of the half mirror 30. As a result, the light appears to be emitted from a position farther than the image display panel 20. Therefore, the user U who sees the light appears to be irradiated with the light from a rear side (side opposite to the user U side) of the image display panel 20. As a result, the video (image) displayed by the image display panel 20 is visually recognized by the user U as a virtual image on the rear side of the image display panel 20.

In addition, approximately half of the levorotatory circularly polarized light reflected by the reflective polarizer 36 and incident on the half mirror 30 is transmitted through the half mirror 30. The transmitted levorotatory circularly polarized light is transmitted through the antireflection layer 28 and is incident on the λ/4 retardation layer 26 to be converted into linearly polarized light. The linearly polarized light is transmitted through the absorption type polarizer 24 and is incident on the λ/4 retardation layer 22 to be converted into circularly polarized light. The circularly polarized light is reflected by a surface or the like of the image display panel 20 and is incident on the λ/4 retardation layer 22 again. In the reflection, a revolution direction of the circularly polarized light is converted to an opposite direction, and thus the circularly polarized light is converted into linearly polarized light in a direction orthogonal to the transmission axis of the absorption type polarizer 26 in the λ/4 retardation layer 22. This linearly polarized light is absorbed by the absorption type polarizer 26.

A virtual reality display device 100B shown in FIG. 4 includes an image display panel 20, a λ/4 retardation layer 22, an absorption type polarizer 24, a λ/4 retardation layer 26, an antireflection layer 28, a half mirror 30, a lens base material 32, a reflective circular polarizer 40, a λ/4 retardation layer 42, and a laminate 38 in this order.

The laminate 38 includes the above-described first protective layer, an absorption type polarizer, and a second protective layer.

A virtual reality display device 100B shown in FIG. 4 has the same configuration as the virtual reality display device 100A shown in FIG. 3 except that a reflective circular polarizer 40 and a λ/4 retardation layer 42 are provided instead of the λ/4 retardation layer 34 and the reflective polarizer 36 in the virtual reality display device 100A shown in FIG. 3.

In the virtual reality display device 100B shown in FIG. 4, the left circularly polarized light is incident on the half mirror 30 as in the virtual reality display device 100A shown in FIG. 3.

Approximately half of the levorotatory circularly polarized light incident on the half mirror 30 is transmitted through the half mirror 30, is transmitted through the lens base material 32, and is incident on the reflective circular polarizer 40. In this case, since the reflective circular polarizer 40 is a circularly polarizing plate which reflects the levorotatory circularly polarized light and transmits the dextrorotatory circularly polarized light, the incident levorotatory circularly polarized light is reflected by the reflective circular polarizer 40 toward the half mirror 30 side.

Approximately half of the levorotatory circularly polarized light reflected by the reflective circular polarizer 40 and incident on the half mirror 30 is reflected by the half mirror 30. In this case, the levorotatory circularly polarized light is converted into dextrorotatory circularly polarized light.

The right circularly polarized light reflected from the half mirror 30 transmits through the lens base material 32 and is incident into the reflective circular polarizer 40. However, since the reflective circular polarizer 40 is a circularly polarizing plate that transmits right circularly polarized light, the incident right circularly polarized light transmits through the reflective circular polarizer 40 and is incident into the λ/4 retardation layer 42. The right circularly polarized light incident into the λ/4 retardation layer 42 is converted into linearly polarized light and is incident into the laminate 38. The absorption type polarizer in the laminate 38 is disposed to allow transmission of the linearly polarized light, and thus the linearly polarized light transmits through the laminate 38 and is emitted toward the user U.

In the first embodiment and the second embodiment, the aspect in which the λ/4 retardation layer is used as the retardation layer has been described, but the type of the retardation layer is not limited to this aspect.

Hereinafter, members other than the laminate included in the virtual reality display device (first embodiment and second embodiment) will be described in detail.

### (Image Display Panel)

The image display panel is, for example, a known image display panel (display panel) such as an organic electroluminescence (EL) display panel.

### (λ/4 Retardation Layer)

The λ/4 retardation layer is a layer having a λ/4 function, and specifically, a layer having a function of converting linearly polarized light at a specific wavelength (preferably, visible light) into circularly polarized light (or converting circularly polarized light at the wavelength into linearly polarized light).

The in-plane retardation of the λ/4 retardation layer at a wavelength of 550 nm is not particularly limited, but is preferably 120 to 150 nm, more preferably 125 to 150 nm, and still more preferably 135 to 150 nm.

In addition to the λ/4 retardation layer, a retardation layer in which the in-plane retardation at a wavelength of 550 nm is ¾ or 5/4 of the wavelength of any light of visible light is also preferable.

### (Absorption Type Polarizer)

The absorption type polarizer is a member that absorbs polarized light (linearly polarized light) in a specific direction.

As the absorption type polarizer, a known absorption type polarizer can be used.

### (Antireflection Layer)

The type of the antireflection layer is not particularly limited, and from the viewpoint of further reducing the reflectivity, a moth-eye film or an anti-reflection (AR) film is preferable.

### (Half Mirror)

The half mirror is a member that transmits about half of incident light and reflects the remaining half. As the half mirror, a half mirror known in the related art can be used.

The transmittance of the half mirror is preferably 50±30% and more preferably 50±10%.

The type of the half mirror is not particularly limited, and examples thereof include a reflective layer consisting of a metal. Examples of the metal include silver and aluminum.

The thickness of the half mirror is preferably 1 to 20 nm, more preferably 2 to 10 nm, and still more preferably 3 to 6 nm.

### (Lens Base Material)

As the lens base material, a known lens base material can be used, and examples thereof include a convex lens and a concave lens.

Examples of the convex lens include a biconvex lens, a plano-convex lens, and a convex meniscus lens. Examples of the concave lens include a biconcave lens, a plano-concave lens, and a concave meniscus lens.

As the lens used in the virtual reality display device, a convex meniscus lens or a concave meniscus lens is preferable for enlarging the angle of view, and a concave meniscus lens is more preferable in that chromatic aberration can be further suppressed.

As a material of the lens base material, a material transparent to visible light, such as glass, crystal, or plastic, can be used.

### (Reflective Polarizer (Reflective Linear Polarizer))

The reflective polarizer is a polarizer that has a function of reflecting one linearly polarized light of linearly polarized light components orthogonal to each other and allowing transmission of the other linearly polarized light.

Examples of the reflective polarizer include a film obtained by stretching a dielectric multilayer film and a wire grid polarizer. Examples of the commercially available product include a reflective polarizer (trade name: APF) manufactured by 3M Company and a wire grid polarizer (trade name: WGF) manufactured by Asahi Kasei Corporation.

### (Reflective Circular Polarizer)

The reflective circular polarizer is a polarizer having a function of reflecting one circularly polarized light of right circularly polarized light and left circularly polarized light and allowing transmission of the other circularly polarized light.

Examples of the reflective circular polarizer include a cholesteric liquid crystal layer.

The virtual reality display device may include other members in addition to the above-described members.

Examples of the other members include a retardation layer such as a positive C-plate, a support, and a pressure sensitive adhesive layer.

### Examples

Hereinafter, the features of the present invention will be described in more detail with reference to Examples. The materials, the used amounts, the proportions, the treatment contents, the treatment procedures, and the like described in Examples can be appropriately changed without departing from the gist of the present invention. In addition, configurations other than the configurations described below can be employed without departing from the gist of the present invention.

### <Preparation of Absorption Type Polarizer>

As a resin base material, a noncrystalline isophthalate copolymer polyethylene terephthalate film (thickness: 100 μm) having a long shape, a water absorption rate of 0.75%, and a glass transition temperature (Tg) of approximately 75° C. was used. One surface of the resin base material was subjected to a corona treatment.

A mixture obtained by adding 13 parts by mass of potassium iodide to 100 parts by mass of a PVA-based resin obtained by mixing polyvinyl alcohol (degree of polymerization: 4200, saponification degree: 99.2 mol %) and acetylated PVA (manufactured by Nippon Synthetic Chemical Industry Co., Ltd., trade name: “GOCERFIMER Z410”) at a ratio of 9:1 was dissolved in water to prepare a PVA aqueous solution (coating solution).

The PVA aqueous solution was applied to the corona-treated surface of the resin base material and dried at 60° C. to form a PVA-based resin layer having a thickness of 13 μm, thereby preparing a laminate.

The obtained laminate was uniaxially stretched 2.4 times in the longitudinal direction (machine direction) between rolls having different circumferential speeds in an oven at 130° C. (air-assisted stretching treatment).

Next, the laminate was immersed in an insolubilization bath (a boric acid aqueous solution obtained by mixing 3.0% by mass of boric acid with respect to the total mass of the boric acid aqueous solution) at a liquid temperature of 40° C. for 30 seconds (insolubilization treatment).

Next, the film was immersed in a dyeing bath (aqueous iodine solution obtained by mixing iodine and potassium iodide at a mass ratio of 1:7 with respect to 100 parts by mass of water) at a liquid temperature of 30° C. for 60 seconds while adjusting the concentration so that the single transmittance (Ts) of the finally obtained polarizer was 43.0% or more (dyeing treatment).

Next, the film was immersed in a crosslinking bath having a liquid temperature of 40° C. (boric acid aqueous solution obtained by mixing 3 parts by mass of potassium iodide and 3.0 parts by mass of boric acid with respect to 100 parts by mass of water) for 30 seconds (crosslinking treatment).

Thereafter, the laminate was uniaxially stretched in the machine direction (longitudinal direction) between rolls having different circumferential speeds to have a total stretching ratio of 5.5 times while being immersed in a boric acid aqueous solution (boric acid concentration: 3.0% by mass, potassium iodide concentration: 5% by mass) at a liquid temperature of 70° C. (in-water stretching treatment).

Thereafter, the laminate was immersed in a washing bath at a liquid temperature of 20° C. (an aqueous solution obtained by mixing 4 parts by mass of potassium iodide with 100 parts by mass of water) (washing treatment).

Thereafter, the obtained laminate was brought into contact with a SUS heating roll having a surface temperature of 75° C. for about 2 seconds while being dried in an oven maintained at 90° C. (drying contraction treatment). The drying shrinkage treatment resulted in a widthwise contraction rate of the laminate of 5.2%.

In this manner, an absorption type polarizer 1 having a thickness of 5 μm was formed on the resin base material. In this case, the content of the dichroic substance in the absorption type polarizer was 0.5 g/m².

Absorption type polarizers 2 to 5 were manufactured according to the same procedure as that for the absorption type polarizer 1, except that the boric acid concentration (% by mass) in the insolubilization bath in the insolubilization treatment, the boric acid amount (parts by mass) in the crosslinking bath in the crosslinking treatment, and the boric acid concentration (% by mass) in the boric acid aqueous solution in the in-water stretching treatment were changed as shown in Table 1.

In Table 1, the column of “Boric acid concentration” indicates a numerical value of “% by mass” for the boric acid concentration (% by mass) in the insolubilization bath in the insolubilization treatment and the boric acid concentration (% by mass) in the boric acid aqueous solution in the water stretching treatment, and indicates a numerical value of “parts by mass” for the amount of boric acid (parts by mass) in the crosslinking bath in the crosslinking treatment. For example, in the absorption type polarizer 2, the boric acid concentration (% by mass) in the insolubilization bath in the insolubilization treatment and the boric acid concentration (% by mass) in the boric acid aqueous solution in the water stretching treatment are 2% by mass, and the boric acid amount (parts by mass) in the crosslinking bath in the crosslinking treatment is 2 parts by mass.

TABLE 1

| | Boric acid |
|---|---|
| | concentration |
| Absorption type polarizer 1 | 3 |
| Absorption type polarizer 2 | 2 |
| Absorption type polarizer 3 | 1 |
| Absorption type polarizer 4 | 0 |
| Absorption type polarizer 5 | 4 |

### <Production of Polymer P1>

A mixture (concentration of solid contents: 50% by mass, proportion of toluene in solvent: 5% by mass) including butyl acrylate (65 parts by mass), methyl acrylate (23 parts by mass), 2-phenoxyethyl acrylate (6 parts by mass), 2,2′-azobisisobutyronitrile (AIBN) (0.1 parts by mass), ethyl acetate, and toluene as a solvent was stirred in a reaction container equipped with a stirrer, a thermometer, a reflux condenser, and a nitrogen gas introduction pipe at 55° C. for 6 hours in a nitrogen atmosphere (polymerization reaction). In this manner, a solution containing an acrylic polymer (polymer P1) was obtained. Thereafter, ethyl acetate was added to the solution to adjust the polymer concentration of the solution to 30% by mass. In this manner, a polymer solution containing an acrylic polymer (polymer P1) was obtained. The weight-average molecular weight of the acrylic polymer in the polymer solution was 1,150,000.

### <Preparation of Protective Layer-Containing Member>

The above-described polymer solution was applied to a corona-treated surface of a transparent polyethylene terephthalate (PET) film having a thickness of 38 μm, in which one surface (first surface) was subjected to a corona treatment, and the film was heated and dried at 130° C. for 2 minutes to form a pressure sensitive adhesive layer having a thickness of 5 μm. A PET film (peelable film) having a thickness of 25 μm, which had been subjected to a peeling treatment with a silicone-based peeling treatment agent on one surface, was bonded to the pressure sensitive adhesive layer, thereby preparing a protective layer-containing member 1 including the PET film subjected to a corona treatment, the protective layer 1 as the pressure sensitive adhesive layer, and the peelable film.

A protective layer-containing member 2 was prepared according to the same procedure as the procedure for preparing the protective layer-containing member 1, except that the thickness of the protective layer was changed from 5 μm to 10 μm.

In addition, a protective layer-containing member 3 was prepared according to the same procedure as the procedure for preparing the protective layer-containing member 1, except that the thickness of the protective layer was changed from 5 μm to 15 μm.

### <Preparation of Laminate>

A PET film (peelable film) on one surface of the protective layer-containing member 1, which had been subjected to a peeling treatment with a silicone-based peeling treatment agent, was removed, the exposed protective layer 1 was bonded to the absorption type polarizer 1, and the resin base material adjacent to the absorption type polarizer 1 was peeled off.

A PET film (peelable film) on which a peeling treatment was performed with a silicone-based peeling treatment agent on one surface was removed from the protective layer-containing member 1, and the protective layer 1 was bonded to a surface of the absorption type polarizer 1 opposite to the surface to which the protective layer 1 was bonded, thereby preparing a laminate 1 including the absorption type polarizer 1 having the protective layer 1 on both surfaces.

A laminate 2 was prepared according to the same procedure as the above-described procedure for preparing the laminate 1, except that the protective layer-containing member 2 was used instead of the protective layer-containing member 1.

In addition, a laminate 3 was prepared according to the same procedure as the above-described procedure for preparing the laminate 1, except that the absorption type polarizer 2 was used instead of the absorption type polarizer 1.

In addition, a laminate 4 was prepared according to the same procedure as the above-described procedure for preparing the laminate 1, except that the absorption type polarizer 3 was used instead of the absorption type polarizer 1.

In addition, a laminate 5 was prepared according to the same procedure as the above-described procedure for preparing the laminate 1, except that the absorption type polarizer 4 was used instead of the absorption type polarizer 1.

In addition, a laminate 6 was prepared according to the same procedure as the procedure for preparing the laminate 1, except that the protective layer-containing member 3 was used instead of the protective layer-containing member 1.

In addition, a laminate 7 was prepared according to the same procedure as the above-described procedure for preparing the laminate 1, except that the absorption type polarizer 5 was used instead of the absorption type polarizer 1.

<Preparation of positive C-plate 1>

A positive C-plate 1 was prepared by adjusting the film thickness with reference to the method described in paragraphs 0132 to 0134 of JP2016-053709A. Re of the positive C-plate 1 was 0.2 nm and Rth thereof was-70 nm.

### <Preparation of Retardation Layer 1>

A retardation layer 1 having reverse dispersibility was prepared with reference to the method described in paragraphs 0151 to 0163 of JP2020-084070A. Re of the retardation layer 1 was 146 nm and Rth thereof was 73 nm.

### <Preparation of Optical Member>

The PET film that had been subjected to a corona treatment was peeled off from both surfaces of the laminate 1 to obtain an absorption type polarizer 1 having protective layers 1 on both surfaces. Next, the phase difference layer 1, the reflective polarizer, the absorption type polarizer 1 having the protective layer 1 on both surfaces, and the phase difference layer 1 were bonded in this order to prepare an optical member 1. The retardation layer 1 and the reflective polarizer were bonded using a pressure sensitive adhesive sheet “NCF-D692 (5)” manufactured by LINTEC Corporation.

An optical member 2 was prepared according to the same procedure as the procedure for preparing the optical member 1, except that the laminate 2 was used instead of the laminate 1.

In addition, an optical member 3 was prepared according to the same procedure as the above-described procedure for preparing the optical member 1, except that the laminate 3 was used instead of the laminate 1.

In addition, an optical member 4 was prepared according to the same procedure as the above-described procedure for preparing the optical member 1, except that the laminate 4 was used instead of the laminate 1.

In addition, an optical member 5 was prepared according to the same procedure as the above-described procedure for preparing the optical member 1, except that the laminate 5 was used instead of the laminate 1.

In addition, an optical member 6 was prepared according to the same procedure as the above-described procedure for preparing the optical member 1, except that the laminate 6 was used instead of the laminate 1.

In addition, an optical member 7 was prepared according to the same procedure as the above-described procedure for preparing the optical member 1, except that the laminate 7 was used instead of the laminate 1.

### <Preparation of Virtual Reality Display Device>

A virtual reality display device “Oculus Quest” manufactured by Facebook was decomposed to take out an image display panel. This image display panel was an organic EL display panel, and a λ/4 retardation layer and an absorption type polarizer bonded to the surface were peeled off.

Next, the prepared retardation layer 1, the absorption type polarizer 5, the retardation layer 1, and the positive C-plate 1 were bonded to the surface of the image display panel in this order using a pressure-sensitive adhesive sheet “NCF-D692 (5)” (manufactured by LINTEC Corporation). In a case where the phase difference layer 1, the absorption type polarizer 5, and the positive C-plate 1 were bonded, the temporary support was peeled off and removed. The image display panel 1 obtained as described above emitted right circularly polarized light.

Next, a concave meniscus lens (made of optical glass) having a diameter of 50 mm and a curvature radius of 65 mm of a curved surface portion, in which one surface was half-mirror-coated, was prepared, and the prepared optical member 1 was molded on the curved surface portion of the concave meniscus lens. That is, the laminate 1 having the curved surface portion was molded. In addition, the laminate 1 (optical member 1) of the concave meniscus lens was molded into a curved surface by the method described in JP2012-116094A in a state where a pressure-sensitive adhesive sheet “NCF-D692 (5)” manufactured by LINTEC Corporation was attached to a bonding surface of the retardation layer 1 in the optical member 1 and a separator film of the pressure-sensitive adhesive sheet was peeled off. A molding temperature was set to 120° C. In this way, the half-mirror-coated concave meniscus lens 1 in which the optical member 1 was bonded to a curved surface was prepared. The optical member 1 was bonded to the concave meniscus lens 1 such that the reflective polarizer was disposed closer to the half mirror coating side than the absorption type polarizer. In this case, the concave meniscus lens 1 was disposed such that the concave surface side was on the visible side, and the virtual reality display device 1 was prepared by installing the concave meniscus lens while adjusting the distance of the concave meniscus lens so that the virtual reality display image was appropriately displayed.

A virtual reality display device 2 was prepared according to the same procedure as the above-described procedure for preparing the virtual reality display device 1, except that the optical member 2 was used instead of the optical member 1.

In addition, a virtual reality display device 3 was prepared according to the same procedure as the above-described procedure for preparing the virtual reality display device 1, except that the optical member 3 was used instead of the optical member 1.

In addition, a virtual reality display device 4 was prepared according to the same procedure as the above-described procedure for preparing the virtual reality display device 1, except that the optical member 4 was used instead of the optical member 1.

In addition, a virtual reality display device 5 was prepared according to the same procedure as the above-described procedure for preparing the virtual reality display device 1, except that the optical member 5 was used instead of the optical member 1.

In addition, a virtual reality display device 6 was prepared according to the same procedure as the above-described procedure for preparing the virtual reality display device 1, except that the optical member 6 was used instead of the optical member 1.

In addition, a virtual reality display device 7 was prepared according to the same procedure as the above-described procedure for preparing the virtual reality display device 1, except that the optical member 7 was used instead of the optical member 1.

### <Evaluation>

### (Quantitative Evaluation of Boric Acid)

The absorption type polarizer 1 was cut into 1 cm×1 cm, 3 cc of nitric acid was added thereto, and then ashing was performed at a maximum temperature of 230° C. by microwave. Water was added to the obtained product to make the total amount 50 g, and then the luminescence intensity of boron was measured using ICP-OES (Optima 7300DV) manufactured by PerkinElmer Inc.

Next, a plurality of aqueous solutions having known boric acid concentrations were prepared, and a calibration curve showing a relationship between a boric acid amount and a luminescence intensity was prepared from the ICP luminescence intensity data of boron measured using each aqueous solution. Using this calibration curve, the amount (g) of boric acid was calculated from the luminescence intensity data of boron measured using the sample of the absorption type polarizer 1. Next, the calculated amount of boric acid (g) was divided by the volume (1 cm×1 cm× thickness) of the sample to calculate the amount of boric acid (g/m³).

The amount of boric acid was calculated for the absorption type polarizers 2 to 5 according to the same procedure.

### (Evaluation of Polarization Degree)

The absorption type polarizer 1 was formed into a curved surface according to the same procedure as the procedure described in <Preparation of virtual reality display device>described above. Regarding the polarization performance of the obtained curved surface-molded absorption type polarizer 1, the central portion of the absorption type polarizer 1 was cut out in a square of 2 cm, bonded to FUJITAC TD80UL (manufactured by Fujifilm Corporation) with a pressure-sensitive adhesive sheet “NCF-D692 (5)” manufactured by LINTEC Corporation, and then the polarization degree was calculated and evaluated by using an automatic polarizing film measuring device VAP-7070 (manufactured by JASCO Corporation) with a visibility-corrected polarization degree. The results are shown in Table 2.

Here, the “visibility-corrected polarization degree” refers to an average value of values obtained by measuring transmittance in a wavelength range of 380 to 780 nm incident from the FUJITAC TD80UL side by installing a light source, a linear polarizer, and the absorption type polarizer 1 in this order, calculating the polarization degree at each wavelength by the following expression, and multiplying the calculated value by a visibility correction coefficient.

$$Polarization degree P ( \% ) = {\{ ( Ty - Tx ) / ( Ty + T x ) \}}^{1 / 2} \times 100$$

Tx: transmittance in a case where the incidence polarized light emitted through the linear polarizer and the transmission axis of the absorption type polarizer 1 are arranged to be crossed nicols (incident light is 100%)
Ty: transmittance in a case where the incidence polarized light emitted through the linear polarizer and the transmission axis of the absorption type polarizer 1 are arranged to be parallel-nicols (incident polarized light is 100%)

The polarization degrees of the absorption type polarizers 2 to 5 were also calculated according to the same procedure.

### (Heat Resistance Test)

A laminate 1 was formed into a curved surface according to the same procedure as the procedure described in <Preparation of virtual reality display device> above. For the laminate 1 which had been formed into a curved surface, a central portion of 2 cm×2 cm was cut out, the PET film was peeled off from one surface, the laminate was bonded to FUJITAC TD80UL (manufactured by FUJIFILM Corporation), and the remaining PET film was peeled off and bonded to FUJITAC TD80UL to prepare a sample. The single plate transmittance of the prepared sample was measured by the following method, and then the sample was set in a constant-temperature and constant-humidity tank and stored for 500 hours under the condition of 85° C. dry to perform a heat resistance test. The single plate transmittance of the sample after the heat resistance test was measured by the following method. From the values of the single plate transmittance before and after the heat resistance test measured by the above method, a transmittance change ΔT of the single plate transmittance (single plate transmittance after the heat resistance test-single plate transmittance before the heat resistance test) was obtained. It can be said that the closer the value of the transmittance change ΔT is to 0, the more excellent the heat resistance is. A to C are levels which do not cause any problems in practical use.

The heat resistance of the laminates 2 to 7 was also evaluated according to the same procedure.
A: Transmittance change ΔT was 0.0% or more and less than 1.0%.
B: Transmittance change ΔT was 1.0% or more and less than 3.0%.
C: Transmittance change ΔT was 3.0% or more and less than 5.0%.
D: Transmittance change ΔT was 5.0% or more.

### —Single Plate Transmittance—

The transmittance refers to an average value of values obtained by multiplying a transmittance measured at a wavelength of 380 to 780 nm using an automatic polarizing film measuring device VAP-7070 (manufactured by JASCO Corporation) by a visibility correction coefficient, and (Tx+Ty)/2 shown in the following definition expression is defined as a single plate transmittance.
Tx: transmittance in a case where the incident polarized light and the transmission axis of the absorption type polarizer in the sample are arranged to be crossed nicols (incident polarized light is 100%)
Ty: transmittance in a case where the incident polarized light and the transmission axis of the absorption type polarizer in the sample are arranged to be parallel-nicols (incident polarized light is 100%)

### <Evaluation of Image Sharpness>

In the prepared virtual reality display devices 1 to 7, a black-and-white checker pattern was displayed on the image display device, and the degree of image sharpness was evaluated by visual observation in the following three stages. In a case where the image sharpness was poor, a part or the entirety of the checker pattern appeared distorted. A or B is preferable.
A: The distortion of the checker pattern was not substantially recognized.
B: The distortion of the checker pattern was slightly recognized, but was not noticeable.
C: The distortion of the checker pattern was clearly recognized.

TABLE 2

| | | Protective | | | Absorption | | | Performance | | |
|---|---|---|---|---|---|---|---|---|---|---|
| | Laminate | layer | | | type | Amount of | | Polarization | Heat | Image |
| | Type | Type | Thickness | | polarizer | boric acid | | degree | resistance | sharpness |
| Example 1 | Laminate 1 | Protective | 5 | μm | Absorption | 0.04 × 10⁻⁶ | g/m³ | 99.9% | A | A |
| | | layer 1 | | | type | | | | | |
| | | | | | polarizer 1 | | | | | |
| Example 2 | Laminate 2 | Protective | 10 | μm | Absorption | 0.04 × 10⁻⁶ | g/m³ | 99.9% | C | A |
| | | layer 2 | | | type | | | | | |
| | | | | | polarizer 1 | | | | | |
| Example 3 | Laminate 3 | Protective | 5 | μm | Absorption | 0.025 × 10⁻⁶ | g/m³ | 99.9% | B | A |
| | | layer 1 | | | type | | | | | |
| | | | | | polarizer 2 | | | | | |
| Example 4 | Laminate 4 | Protective | 5 | μm | Absorption | 0.015 × 10⁻⁶ | g/m³ | 99.9% | C | A |
| | | layer 1 | | | type | | | | | |
| | | | | | polarizer 3 | | | | | |
| Comparative | Laminate 5 | Protective | 5 | μm | Absorption | 0 | g/m³ | 99.9% | D | A |
| Example 1 | | layer 1 | | | type | | | | | |
| | | | | | polarizer 4 | | | | | |
| Comparative | Laminate 6 | Protective | 15 | μm | Absorption | 0.04 × 10⁻⁶ | g/m³ | 99.9% | D | A |
| Example 2 | | layer 3 | | | type | | | | | |
| | | | | | polarizer 1 | | | | | |
| Comparative | Laminate 7 | Protective | 5 | μm | Absorption | 0.06 × 10⁻⁶ | g/m³ | 99.9% | A | C |
| Example 3 | | layer 1 | | | type | | | | | |
| | | | | | polarizer 5 | | | | | |

As shown in Table 2, the laminate according to the embodiment of the present invention exhibited a desired effect.

From the comparison of Examples 1 and 2, it was confirmed that the heat resistance was more excellent in a case where the thickness of the protective layer was 8.0 μm or less.

From the comparison of Examples 1 and 3 to 4, it was confirmed that in a case where the amount of the crosslinking agent was 0.020×10⁻⁶ g/m³ or more, the heat resistance was more excellent, and in a case where the amount of the crosslinking agent was 0.030×10⁻⁶ g/m³ or more, the heat resistance was further excellent.

### EXPLANATION OF REFERENCES

10, 38: laminate
12, 26: absorption type polarizer
14: first protective layer
16: second protective layer
20: image display panel
22, 26, 34, 42: λ/4 retardation layer
28: antireflection layer
30: half mirror
32: lens base material
36: reflective polarizer
38: laminate
40: reflective circular polarizer

What is claimed is:

1. A laminate comprising:
an absorption type polarizer that is a stretched resin film;
a first protective layer disposed on one surface side of the absorption type polarizer; and
a second protective layer disposed on the other surface side of the absorption type polarizer,
wherein the laminate has a curved surface portion,
the absorption type polarizer contains a resin having a crosslinked portion,
an amount of a crosslinking agent derived from the crosslinked portion is 0.050×10⁻⁶ g/m³ or less,
thicknesses of both the first protective layer and the second protective layer are 0.10 to 10 μm, and
both the first protective layer and the second protective layer contain a resin selected from the group consisting of an acrylic resin and a methacrylic resin.

2. A laminate comprising:
an absorption type polarizer that is a stretched resin film;
a first protective layer disposed on one surface side of the absorption type polarizer; and
a second protective layer disposed on the other surface side of the absorption type polarizer,
wherein the laminate has a curved surface portion,
the absorption type polarizer contains a resin having a boric acid crosslinked portion,
an amount of a boric acid derived from the boric acid crosslinked portion is 0.050×10⁻⁶ g/m³ or less,
thicknesses of both the first protective layer and the second protective layer are 0.10 to 10 μm, and
both the first protective layer and the second protective layer contain a resin selected from the group consisting of an acrylic resin and a methacrylic resin.

3. The laminate according to claim 1,
wherein the absorption type polarizer contains iodine and a polyvinyl alcohol-based resin.

4. A virtual reality display device comprising, in the following order:
an image display panel;
an absorption type polarizer;
a first retardation layer;
a half mirror;
a second retardation layer;
a reflective polarizer; and
the laminate according to claim 1.

5. A virtual reality display device comprising, in the following order:
an image display panel;
an absorption type polarizer;
a retardation layer;
a half mirror;
a reflective circular polarizer; and
the laminate according to claim 1.

6. The laminate according to claim 2,
wherein the absorption type polarizer contains iodine and a polyvinyl alcohol-based resin.

7. A virtual reality display device comprising, in the following order:
an image display panel;
an absorption type polarizer;
a first retardation layer;
a half mirror;
a second retardation layer;
a reflective polarizer; and
the laminate according to claim 2.

8. A virtual reality display device comprising, in the following order:
an image display panel;
an absorption type polarizer;
a retardation layer;
a half mirror;
a reflective circular polarizer; and
the laminate according to claim 2.

9. A virtual reality display device comprising, in the following order:
an image display panel;
an absorption type polarizer;
a first retardation layer;
a half mirror;
a second retardation layer;
a reflective polarizer; and
the laminate according to claim 3.

10. A virtual reality display device comprising, in the following order:
an image display panel;
an absorption type polarizer;
a retardation layer;
a half mirror;
a reflective circular polarizer; and
the laminate according to claim 3.
